(19) United States
(12) Patent Application Publication
(10) Pub. No.: US 2020/0136218 A1
(43) Pub. Date: Apr. 30, 2020

(54) METAL-AIR BATTERY

(71) Applicant: Fuji Pigment Co., Ltd., Kawanishi-shi, Hyogo (JP)

(72) Inventor: Ryohei MORI, Kawanishi-shi, Hyogo (JP)

(21) Appl. No.: 16/606,097

(22) PCT Filed: Apr. 6, 2018
(86) PCT No.: PCT/JP2018/014708

§ 371 Date: Oct. 17, 2019

(30) Foreign Application Priority Data
Apr. 17, 2017 (JP) 2017-081271

(51) Int. Cl. H01M 12/06; H01M 12/08; H01M 4/90; H01M 4/96

(52) U.S. Cl. CPC H01M 12/06; H01M 4/96; H01M 4/9066; H01M 12/08

(57) ABSTRACT

Provided is a metal-air battery which is improved in battery performance such as stability in charge/discharge cycle characteristics by suppressing the generation of byproducts not only on the metal anode but also on the air cathode. A metal-air battery of the present invention includes an anode 1, an air cathode 3 and an electrolyte 2 that is interposed between the anode 1 and the air cathode 3, wherein the anode 1 contains aluminum, the electrolyte 2 contains an ionic liquid or a non-aqueous electrolyte solution, and the air cathode 3 contains a non-oxide ceramic.

### TECHNICAL FIELD

The present invention relates to a metal-air battery including an anode, an air cathode, and an electrolyte that is interposed between the anode and the air cathode.

### BACKGROUND ART

In a common metal-air battery, a metal is used as an anode, a liquid electrolyte is used as an electrolyte, an air cathode is used as a cathode, and oxygen in air is used as a cathode active material. In the metal-air battery, it is not necessary to incorporate the cathode active material in the battery because oxygen present in the air is used as the cathode active material. Further, it is possible to fill most of a space in a battery container with an anode active material. Accordingly, in principle, the battery has the largest energy density among chemical batteries. Therefore, size and weight reduction of the battery or high capacity of the battery can be expected.

In the metal-air battery, the reduction of oxygen is performed at the air cathode, and the dissolution of metal accompanied by electron emission is performed at the anode, upon discharging. Therefore, byproducts such as a metallic hydroxide are easily generated on the anode and the like during the use of the battery, and the generated byproducts are gelled and non-fluidized. Thus, the discharge of the battery or the like is inhibited, thereby deteriorating the capacity and voltage. For example, the equation shown below represents the reaction between Al and air upon discharging assuming the case of the aluminum-air battery which uses aluminum for the anode.

### Upon Discharging

Anode: Al+3OH⁻→Al(OH)₃+3e⁻

Air Cathode: ¾O₂+ 3/2H₂O+3e⁻→3OH⁻

Patent Document 1 describes that a high molecule, an oxo-acid salt, and the like are added to the electrolyte in order to suppress the accumulation of byproducts. However, an effect sufficient to suppress the accumulation of byproducts has not been obtained. On the other hand, Non-Patent Documents 1 to 3 have reported that ionic liquid based electrolytes such as 1-ethyl-3-methylimidazolium chloride and 1-butyl-3-methylimidazolium are used for the purpose of suppressing the accumulation of byproducts on the aluminum anode. However, even if the electrolytes are used, byproducts are still observed on the air cathode and further electrochemical reactions are inhibited.

Further, Non-Patent Document 4 discloses that when 1-ethyl-3-methylimidazolium chloride or the like is used as an electrolyte solution in an aluminum-air battery, aluminum oxide or the like (i.e., byproducts) does not deposit on the side of a metal anode, and thus the aluminum-air battery can be formed into a secondary battery.

### PRIOR ART DOCUMENTS

### Patent Document

Patent Document 1: JP-A-2012-015026

### Non-Patent Documents

Non-Patent Document 1: 13. R. Revel, T. Audichon & S. Gonzalez, J. Power Sources, 2014, 272, 415-421.

Non-Patent Document 2: 14. D. Gelman, D., B. Shvartsev & Y. Ein-Eli, J. Mater. Chem. A., 2014, 2, 20237-20242.

Non-Patent Document 3: 15. H. Wang et al., ACS Appl. Mater. Interfaces, 2016, 8, 27444-27448.

Non-Patent Document 4: “Press Release from @Press”, SOCIALWIRE CO., LTD. [Searched on Sep. 2, 2016], Internet <URL:https://www.atpress.ne.jp/news/111056>

### SUMMARY OF THE INVENTION

### Problems to be Solved by the Invention

However, it was found out that the use of the ionic liquid as the electrolyte solution as in Patent Document 4 can suppress the generation of byproducts on the side of the metal anode, but cannot sufficiently suppress the generation of byproducts on the air cathode, so that there is room for further improvement in the battery performance.

Therefore, an object of the present invention is to provide a metal-air battery which is improved in battery performance such as stability in charge/discharge cycle characteristics by suppressing the generation of byproducts not only on the metal anode but also on the air cathode.

### Means for Solving the Problems

The present inventors have conducted intensive studies to achieve the above object. They have found out that, in an aluminum-based metal-air battery, an electrolyte containing an ionic liquid or a non-aqueous electrolyte solution is used to produce an air cathode containing a non-oxide ceramic, whereby it is possible to suppress the generation of byproducts not only on the metal anode but also on the air cathode. As a result, the present invention has been completed.

Hence, a metal-air battery of the present invention includes: an anode; an air cathode; and an electrolyte that is interposed between the anode and the air cathode, where the anode contains aluminum, the electrolyte contains an ionic liquid or a non-aqueous electrolyte solution, and the air cathode contains a non-oxide ceramic. According to the metal-air battery of the present invention, it is possible to achieve improvement in battery performance such as stability in charge/discharge cycle characteristics by suppressing the generation of byproducts on both the metal anode and the air cathode.

Details of the reason why the generation of byproducts on the air cathode can be suppressed by using the air cathode containing a non-oxide ceramic in the present invention are not clear, it is considered as follows, for example. In the case of using activated carbon or the like, as shown in the lower right of FIG. 10(a), Al(OH)₃ and Al₂O₃ phases are generated on the air cathode, whereas, in the case of using a non-oxide ceramic, the reactions of equations (11) and (12) described later are promoted, whereby it is possible to suppress the reaction of equation (7) described later and the generation of Al₂O₃ byproducts.

Furthermore, in a case where the ionic liquid is used as the electrolyte, in particular, byproducts such as aluminum hydroxide and aluminum oxide are less likely to be generated on the anode side upon discharging. Accordingly, it is possible to suppress an adverse effect (e.g., inhibition of battery discharge due to gelation or the like) due to byproducts, which is more advantageous in improving the battery performance. Although the reason for this is unknown, it is presumed that the metal ion generated upon discharging is more stable with the ionic liquid than with the hydroxide ion. There are also reports that aluminum metal can be deposited from aluminum ions in the ionic liquid (Ashraf Bakkar, Volkmar Neubert, Electrochimica Acta 103 (2013) 211-218). Further, the electrolyte contains the ionic liquid or the like, so that the evaporation of the electrolyte solution can be suppressed, the battery life can be extended, and the battery performance can be improved.

In the above, the non-oxide ceramic preferably contains a metal carbide, a nitride, a boride, an oxynitride, a carbonitride or a silicide. The non-oxide ceramic is preferably used in terms of promoting the reactions of equations (11) and (12) described later.

Preferably, a metal constituting the non-oxide ceramic is at least one selected from the group consisting of titanium, zirconium, sodium, calcium, barium, magnesium, aluminum, silicon, vanadium, chromium, manganese, iron, cobalt, nickel, copper, zinc, gallium, yttrium, niobium, tin, tungsten, tantalum, indium, lanthanum, lead, strontium, bismuth, cerium, molybdenum, and hafnium. Such a non-oxide ceramic is preferably used particularly in terms of promoting the reactions of equations (11) and (12) described later.

In particular, the non-oxide ceramic is preferably at least one selected from the group consisting of titanium nitride and titanium carbide.

Further, the air cathode preferably contains a non-oxide ceramic and carbon. Thus, the current can be enhanced while suppressing the formation of byproducts.

In the present invention, preferably, a cation in the ionic liquid is at least one selected from the group consisting of imidazolium, pyridinium, ammonium, pyrrolidinium, pyrazolium, piperidinium, morpholinium, sulfonium, and phosphonium; and an anion in the ionic liquid is at least one selected from the group consisting of a halogen ion, an amide ion, an imide ion, a fluoride ion, a sulfate ion, a phosphate ion, a fluorosulfate ion, a lactate ion, and a carboxylate ion. Thus, the viscosity can be adjusted, and the ion conductivity can be enhanced, which is advantageous in realizing the effects of the present invention. In addition, the ionic liquid is used, whereby byproducts such as metallic hydroxide are less likely to be generated on the anode side upon discharging. Accordingly, it is possible to suppress an adverse effect (e.g., inhibition of battery discharge due to gelation or the like) due to byproducts, and improve battery performance.

The metal-air battery of the present invention is preferably a metal-air battery for a primary battery or a secondary battery. Accordingly, it is possible to provide a battery with high volume energy density as the metal-air battery for a primary battery or a secondary battery.

### BRIEF DESCRIPTION OF THE DRAWINGS

FIG. 1 is a schematic view showing an example of the metal-air battery of the present invention.

FIG. 2 is a diagram showing a cyclic voltammogram of a metal-air battery of Example 1-1.

FIG. 3 is a diagram showing a cyclic voltammogram of a metal-air battery of Example 1-2.

FIG. 4 is a diagram showing a cyclic voltammogram of a metal-air battery of Example 2-1.

FIG. 5 is a diagram showing a cyclic voltammogram of a metal-air battery of Example 2-2.

FIG. 6 is a diagram showing a cyclic voltammogram of a metal-air battery of Example 3-1.

FIG. 7 is a diagram showing a cyclic voltammogram of a metal-air battery of Example 3-2.

FIG. 8(a) is a diagram showing charge-discharge curves of a metal-air battery of Example 2-1 (air cathode: TiC). FIG. 8(b) is a diagram showing voltage versus time plot during charging and discharging of the metal-air battery of Example 2-1 (air cathode: TiC).

FIG. 9 is a diagram showing X-ray diffraction patterns (Δ indicates a peak of metallic aluminum) of the aluminum anode after the electrochemical reaction in each of the Examples.

FIG. 10(a) shows X-ray diffraction patterns of the air cathode after the electrochemical reaction in each of the Examples and Comparative Example. FIG. 10(b) is an enlarged image of the X-ray-diffraction patterns of the air cathode after the electrochemical reaction in each of the Examples (in the figures, each black circle indicates TiN, each cross indicates TiC, each white square indicates TiB₂, each plus indicates Al(OH)₃, and each white circle indicates Al₂O₃).

FIG. 11(a) is a diagram showing X-ray photoelectron spectra of aluminum 2p orbital in the air cathode after the electrochemical reaction in Example 2-1 (air cathode: TiC) and Comparative Example 1 (air cathode: AC). FIG. 11(b) is a diagram showing X-ray photoelectron spectra of carbon is orbital in the air cathode after the electrochemical reaction in Example 2-1 (air cathode: TiC) and Comparative Example 1 (air cathode: AC).

FIG. 12 shows photographs when the air cathode was observed using a field-emission scanning electron microscope (FE-SEM) in each of the Examples and Comparative Example. FIG. 12(a) shows the AC air cathode before the electrochemical reaction, FIG. 12(b) shows the AC air cathode after the electrochemical reaction, and FIG. 12(c) shows EDX mapping analysis of FIG. 12(b). FIG. 12(d) shows the TiC air cathode before the electrochemical reaction, FIG. 12(e) shows the TiC air cathode after the electrochemical reaction, and FIG. 12(f) shows EDX mapping analysis of FIG. 12(e).

FIG. 13(a) shows an initial Nyquist plot of an aluminum-air battery with the TiN air cathode before the electrochemical reaction. FIG. 13(b) shows an equivalent circuit of the aluminum-air battery.

### MODE FOR CARRYING OUT THE INVENTION

Hereinafter, the embodiments of the metal-air battery of the present invention will be described. However, the present invention is not limited to the following embodiments at all, and can be implemented with appropriate modifications within the scope of the object of the present invention. In one or more of the drawings, or the whole thereof, parts or moieties unnecessary for the description are omitted, and the drawing(s) may be enlarged or reduced in scale to be illustrated in order to make the description easy. The term “upward and downward” or any other term showing a positional relationship is used merely to make the description easy, and never has an intention of restricting any constituent of the present invention.

### Metal-Air Battery

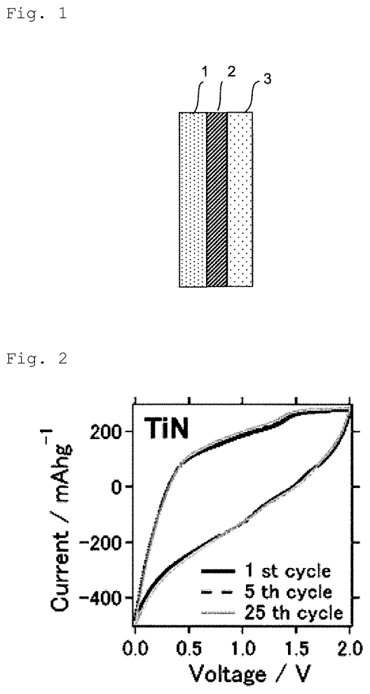

FIG. 1 is a view showing the present embodiment which is an example of preferred embodiments in the metal-air battery of the present invention. As shown in FIG. 1, the metal-air battery of the present invention includes an anode 1, an air cathode 3, and an electrolyte 2 that is interposed between the anode 1 and the air cathode 3. The metal-air battery of the present invention is based on a structure in which the electrolyte 2 is sandwiched between the anode 1 and the air cathode 3. As for configurations other than the configuration, the conventionally-known configurations can be adopted without particular limitation.

For example, the anode 1 can be composed of a metal plate such as an aluminum plate. The electrolyte 2 can have a structure in which a material functioning as a separator holds an electrolyte solution, or the electrolyte solution is partitioned by the separator. Further, the air cathode 3 can have a structure in which a catalytic air cathode material is supported on a metal porous plate such as a metal mesh. Furthermore, an ion conductor such as a solid electrolyte may be interposed between the anode 1 and the air cathode 3. Hereinafter, each structure of the metal-air battery of present invention will be described.

### Anode

Among metals that are oxidized to generate metal ions and electrons and function as anode active materials, the metal containing aluminum is used for the anode in the present invention, from the viewpoint of increasing the theoretical energy density. Examples of the metal containing aluminum include an aluminum pure metal and an aluminum alloy.

As for the aluminum alloy, it is possible to alloy aluminum as a main metal using Li, Mg, Sn, Zn, In, Mn, Ga, Bi, Fe, and the like, singly or in combination of two or more kinds thereof. Among them, aluminum alloys such as Al—Li, Al—Mg, Al—Sn, and Al—Zn are particularly preferable because the aluminum alloys give a high battery voltage.

The materials can act as the anode active materials which can release and absorb metal ions. The anode may contain only the materials, and may contain at least one of a conductive material and a binder in addition to the materials. For example, in a case where the materials have a foil shape, a plate shape, a mesh (grid) shape or the like, it is possible to produce an anode which contains only the materials. On the other hand, in a case where the materials have a powder shape or the like, it is possible to produce an anode which contains the materials and the binder. Note that the contents of the conductive material and the binder are similar to the contents described in the “air cathode” section, and thus the description thereof is omitted here.

The anode may include an anode current collector that collects current of the anode, if necessary. The material of the anode current collector is not particularly limited as long as it has conductivity, and examples thereof include copper, stainless steel, nickel, and carbon. Examples of the shape of the anode current collector include a foil shape, a plate shape, and a mesh (grid) shape. In the present invention, a battery case may have the function of the anode current collector.

The thickness of the anode current collector varies depending on the application of the metal-air battery and the like, and it is preferably in the range of 10 μm to 1000 μm, and particularly preferably in the range of 20 μm to 400 μm.

The method of producing the anode is not particularly limited, and any known method can be used. For example, commercially available plate-shaped materials (for example, the materials as mentioned above) can be used as they are. For example, in the case of using aluminum as a commercially available plate-shaped material, a so-called “pure aluminum” material (Al component: 99% or more) such as A1100, A1050 or A1085 is cut into a predetermined shape (e.g., a circle shape, a tape shape or a plate shape) and the resultant is used as it is. Further, for example, the foil-shaped metal material and the anode current collector can be stacked and pressurized. As another method, there is, for example, a method of preparing an anode material mixture containing an anode active material, a binder, and the like, and coating the anode current collector with the mixture, and drying the coated anode current collector.

The thickness of the anode varies depending on the application of the metal-air battery and the like. In a case where the material has a foil shape, a plate shape or the like, the thickness is preferably in the range of 2 μm to 10 mm, and particularly preferably in the range of 5 μm to 2 mm.

### Air Cathode

The air cathode in the present invention can include a catalytic layer and a cathode current collector, and the catalytic layer can contain a catalytic air cathode material. The catalytic layer can have a role of absorbing oxygen from the air and causing the absorbed oxygen to react with oxygen. The air cathode in the present invention contains a non-oxide ceramic that functions as the catalytic air cathode material. In the present invention, the “non-oxide ceramic” refers to a ceramic other than an oxide ceramic composed only of a metal oxide.

A metal carbide, a metal nitride, a metal boride, a metal oxynitride, a metal carbonitride or a metal silicide is preferable as the non-oxide ceramic. From the viewpoint of suppressing generation of byproducts on the air cathode and improving battery performance such as stability in charge/discharge cycle characteristics, a carbide, a nitride and a boride are more preferable, and a carbide and a nitride are particularly preferable.

Preferably, a metal constituting the non-oxide ceramic is at least one selected from the group consisting of titanium, zirconium, sodium, calcium, barium, magnesium, aluminum, silicon, vanadium, chromium, manganese, iron, cobalt, nickel, copper, zinc, gallium, yttrium, niobium, tin, tungsten, tantalum, indium, lanthanum, lead, strontium, bismuth, cerium, molybdenum, and hafnium. From the viewpoint of suppressing generation of byproducts on the air cathode and improving battery performance such as stability in charge/discharge cycle characteristics, titanium, zirconium, tantalum, and vanadium are more preferable.

Among the non-oxide ceramics, at least one selected from the group consisting of titanium nitride and titanium carbide is preferable, in particular, from the viewpoint of suppressing the generation of byproducts on the air cathode.

The content of the catalytic air cathode material is not particularly limited. For example, in a case where the mass of the entire catalytic layer is 100 wt %, the content is preferably in the range of 30 to 95 wt %, and particularly preferably in the range of 40 to 80 wt %, from the viewpoint of improving the battery characteristics.

The catalytic layer may further contain a conductive material in order to improve the conductivity. The conductive material may be any material that can impart conductivity to the catalytic air cathode material or improve the conductivity of the catalytic air cathode material, and examples thereof include carbon black (such as ketjen black and acetylene black), carbonaceous materials (such as carbon nanotubes), and conductive polymers (such as polythiazyl and polyacetylene). Among them, carbonaceous materials are preferable, and ketjen black, carbon nanotubes, and the like are particularly preferable, when used as electrode materials of air batteries, from the viewpoint of having mesopores on the surface and storing discharge deposits. The conductive material also functions as a carbon-alloy carrier in some cases. However, when a large amount of carbon-based material is contained, byproducts may be formed on the air cathode.

The content ratio of the conductive material is not particularly limited. In a case where the mass of the entire catalytic layer is 100 wt %, the content ratio is preferably less than 20 wt %, and more preferably in the range of 1 to 10 wt %, from the viewpoint of securing the conductivity.

The catalytic layer may further contain a binder in order to immobilize the catalytic air cathode material. The binder may contain a support which is not intended for current collection. Examples of the binder include olefin resins such as polyethylene and polypropylene, fluorine-based resins such as polyvinylidene fluoride (PVDF) and polytetrafluoroethylene (PTFE), and rubber-based resins such as polyamide resin and styrene-butadiene rubber (SBR rubber).

The content ratio of the binder is not particularly limited. In a case where the mass of the entire catalytic layer is 100 wt %, the content ratio is preferably less than 60 wt %, and more preferably in the range of 5 to 50 wt %, from the viewpoint of securing the conductivity.

A solvent can be used to form a paste containing a catalytic air cathode material, a conductive material, a binder, and the like. The solvent is not particularly limited as long as it has volatility, and can be appropriately selected. Specific examples of the solvent include acetone, N,N-dimethylformamide (DMF), and N-methyl-2-pyrrolidone (NMP). A solvent having a boiling point of 200° C. or less is preferable because it is easy to dry the air cathode mixture paste.

The content ratio of the solvent is not particularly limited. In a case where the mass of the entire catalytic layer is 100 wt %, the content ratio is preferably less than 60 wt %, and more preferably in the range of 5 to 50 wt %, from the viewpoint of easiness of coating.

The mixing ratio (weight ratio) among the catalytic air cathode material, the conductive material, the binder, and the solvent is preferably 40 to 60:1 to 10:5 to 15:20 to 40, from the viewpoint of easiness of coating.

The thickness of the catalytic layer varies depending on the application of the metal-air battery and the like, and it is preferably in the range of 2 μm to 500 μm, particularly and preferably in the range of 5 μm to 300 μm.

A material having a conventional morphology as a current collector (e.g., a porous structure such as carbon paper or metal mesh, a net-like structure, a fiber, a nonwoven fabric, a foil shape or a plate shape) can be used as the cathode current collector without particular limitation. Among them, the porous structure such as carbon paper or metal mesh is preferable from the viewpoint of high oxygen supply performance and excellent current collection efficiency. For example, a metal mesh formed of SUS, nickel, aluminum, iron, titanium or the like can be used. A metal foil having oxygen supply holes can also be used as another cathode current collector. The battery case may have the function of the cathode current collector.

The thickness of the cathode current collector varies depending on the application of the metal-air battery and the like, and it is preferably in the range of 10 μm to 1000 μm, and particularly preferably in the range of 20 μm to 400 μm.

The catalytic layer may contain a cathode current collector therein. The cathode current collector may be located at the center of the catalytic layer or may be present in a layer on one side of the catalytic layer. In a case where the cathode current collector is present on one side of the catalytic layer, the cathode current collector may be usually disposed on the side in contact with the air which is opposite to the electrolyte. The shape of the catalytic layer includes not only a layer shape but also other shapes (e.g., a pellet shape, a plate shape, and a mesh shape).

The method of producing an air cathode is not particularly limited, and any known method can be used. For example, an air cathode mixture paste is prepared by mixing at least the catalytic air cathode material in the present invention with a conductive material, a binder, a solvent, and the like, if necessary, the resulting paste is applied to a surface of a cathode current collector and dried, thereby producing an air cathode in which the catalytic layer and the cathode current collector are laminated. Alternatively, a catalytic layer obtained by applying and drying the air cathode mixture paste is layered on a cathode current collector, and the catalytic layer and the cathode current collector are appropriately pressurized or heated, thereby producing an air cathode in which the catalytic layer and the cathode current collector are laminated. The method of applying the air cathode mixture paste is not particularly limited, and a general method such as a doctor blade method or a spray method can be used.

The thickness of the space for supplying air varies depending on the application of the metal-air battery and the like. In a case where the material has a foil shape, a plate shape or the like, the thickness is preferably in the range of 2 μm to 10 mm, and particularly preferably in the range of 5 μm to 2 mm.

### Electrolyte

The electrolyte in the present invention is held between the anode and the air cathode. The electrolyte in the present invention has a function of exchanging metal ions between the anode and the air cathode, and the like. The electrolyte in the present invention contains at least one selected from the group consisting of an ionic liquid and a non-aqueous electrolyte solution. From the viewpoint of suppressing the generation of byproducts, the electrolyte in the present invention preferably contains the ionic liquid.

Here, the “ionic liquid” is a compound composed of a combination of an anion and a cation, and means a salt which is present as a liquid even at room temperature. Depending on the combination of an anion and a cation, multiple ionic liquids are conceivable. Examples of the cation include cations derived from aromatic amines such as imidazolium (e.g., dialkylimidazolium) and pyridinium (e.g., alkylpyridinium); and cations derived from aliphatic amines such as ammonium (e.g., tetraalkylammonium) and pyrrolidinium (e.g., cyclic pyrrolidinium). Examples of the anion include halogen ions such as Cl⁻, Br⁻, and I⁻; and fluoride ions such as BF₄⁻, PF₆⁻, CF₃SO₃⁻, and (CF₃SO₂)₂N⁻. Recently, an imidazolium salt composed of nitric acid or acetic acid may form an ionic liquid, or a general-purpose anion such as alkylsulfonic acid or a polyvalent anion such as sulfuric acid or phosphoric acid may form an ionic liquid. Hence, there is also a non-halogen-based ionic liquid as described above. Further, there are increasing cases in which an ionic liquid is made of naturally occurring ions such as amino acids, sugars, sugar derivatives, and lactic acid. In addition, there are an ionic liquid in which a S (sulfur)-containing ion and a carboxylate ion are used as anions, and an ionic liquid in which phosphonium and sulfonium are used as cations.

Further, with a hydrophobic ionic liquid having a melting point of several tens of degrees Celsius or less, it is possible to suppress the deterioration of the characteristics of the air battery caused by the volatilization of the electrolyte. Furthermore, since the ionic liquid may change due to residual moisture and the like, it is preferable to dry the ionic liquid before use. The drying method may be any known drying method.

Preferably, the cation in the ionic liquid is at least one selected from the group consisting of imidazolium, pyridinium, ammonium, pyrrolidinium, pyrazolium, piperidinium, morpholinium, sulfonium, and phosphonium; and the anion in the ionic liquid is at least one selected from the group consisting of a halogen ion, an amide ion, an imide ion, a fluoride ion, a sulfate ion, a phosphate ion, a fluorosulfate ion, a lactate ion, and a carboxylate ion, from the viewpoint of suppression of generation of byproducts, high ion conductivity, low volatility, high thermal stability. The cation and the anion as described above can be freely combined. Each of the cation and the anion may be used singly, or in combination of two or more kinds thereof.

Examples of representative cations include imidazolium, pyridinium, ammonium, pyrrolidinium, pyrazolium, piperidinium, morpholinium, sulfonium, and phosphonium, from the viewpoint of suppression of generation of byproducts.

Specific examples of the imidazolium include dialkylimidazolium (e.g., 1-ethyl-3-methylimidazolium (EMIm) or 1-butyl-3-methylimidazolium (BMIm)), 1-ethyl-2,3-dimethylimidazolium, 1-allyl-3-methylimidazolium, 1-allyl-3-ethylimidazolium (AEIm), 1-allyl-3-butylimidazolium, and 1,3-diallylimidazolium (AAIm).

Examples of the pyridinium include alkylpyridinium (such as 1-propylpyridinium or 1-butylpyridinium), 1-ethyl-3-(hydroxymethyl)pyridinium, and 1-ethyl-3-methylpyridinium.

Examples of the ammonium include tetraalkyl ammonium such as N,N,N-trimethyl-N-propylammonium (TMPA), N,N-diethyl-N-methyl-N-(2-methoxyethyl)ammonium (DEME), and methyltrioctylammonium.

Examples of the pyrrolidinium include N-methyl-N-propylpyrrolidinium (P13), N-methyl-N-butylpyrrolidinium (P14), and N-methyl-N-methoxymethylpyrrolidinium.

Examples of the pyrazolium include 1-ethyl-2,3,5-trimethylpyrazolium, 1-propyl-2,3,5-trimethylpyrazolium, and 1-butyl-2,3,5-trimethylpyrazolium.

Examples of the piperidinium include N-methyl-N-propylpiperidinium (PP13) and N,N,N-trimethyl-N-propylammonium.

Examples of the morpholinium include N,N-dimethylmorpholinium, N-ethyl-N-methylmorpholinium, and N,N-diethylmorpholinium.

Examples of the sulfonium include trimethylsulfonium, tributylsulfonium, and triethylsulfonium.

Examples of the phosphonium include tributylhexadecylphosphonium, tributylmethylphosphonium, tributyl-n-octylphosphonium, tetrabutylphosphonium, tetra-n-octylphosphonium, tetrabutylphosphonium, and tributyl(2-methoxyethyl)phosphonium.

Examples of the anion that is combined with the cation to form the ionic liquid include a halogen ion, an amide ion, an imide ion, a fluoride ion, a sulfate ion, a phosphate ion, a fluorosulfate ion, a lactate ion, and a carboxylate ion, from the viewpoint of suppression of generation of byproducts.

Specific examples of the halogen ion include Cl⁻, Br⁻, and I⁻. Further, examples of the halogen ion include a compound containing halogen such as an oxo acid ion of halogen (YO₄⁻, YO₃⁻, YO₂⁻ or YO⁻; Y represents Cl, Br or I), AlX₄⁻ (X is Cl, Br or I, and each X is the same or different, i.e., AlX₄⁻ is, for example, AlCl₄⁻, AlBr₄⁻, AlI₄⁻, AlClBr₃⁻, AlClI₃⁻, AlCl₂BrI⁻, AlClBr₂I⁻ or AlClBrI₂⁻), and the like.

Examples of the amide ion include bis(trifluoromethanesulfonyl)amide ion (N(SO₂CF₃)₂⁻) and bis(fluorosulfonyl)amide ion.

Examples of the imide ion include bis(trifluoromethylsulfonyl)imide ion (TFSI⁻), (CF₃SO₂)₂N⁻, (C₂F₅SO₂)₂N⁻, (C₃F₇SO₂)₂N⁻, (CF₃SO₂) (C₂F₅SO₂)N⁻, (CF₃SO₂) (C₃F₇SO₂)N⁻, (C₂F₅SO₂) (C₃F₇SO₂)N⁻, and N(C₄F₉SO₂)₂⁻.

Examples of the fluoride ion include tetrafluoroborate ion (BF₄⁻), hexafluorophosphate ion (PF₆⁻), and SbF₆⁻.

Examples of the sulfate ion include HSO₄⁻, methosulfate ion (CH₃OSO₃⁻), CH₃SO₃⁻, C₄H₉OSO₃⁻, CH₃C₆H₄SO₃⁻, C₈H₁₆SO₃⁻, C₂H₅OSO₃⁻, C₆H₁₃OSO₃⁻, C₈H₁₇OSO₃⁻, and C₄F₉SO₃⁻.

Examples of the phosphate ion include fluorophosphate ion (e.g., hexafluorophosphate ion (PF₆⁻) or C2F₅)₃PF₃⁻), hypophosphite ion (H₂PO₂⁻), (C₂F₅)₃PF₃⁻, (CH₃)₂PO₄⁻, (C₂H₅)₂PO₄⁻, and (CH₅)₂PO₄⁻.

Examples of the fluorosulfate ion include (CF₃SO₂)₂N⁻ and CF₃SO₃⁻.

Examples of the lactate ion include C₂O₃H⁻.

Examples of the carboxylate ion include acetate ion (CH₃COO⁻), CH₃OCO₂⁻, and C₉H₁₉CO₂⁻.

In addition, examples of the anion include a thiocyanate ion (SCN⁻), a nitrate ion (NO₃⁻), a hydrogencarbonate ion (HCO₃⁻), a trifluoromethanesulfonate ion, a dicyanamide ion, B(C₆H₅)₄⁻, a tetraphenylborate ion (BPh₄⁻), B(C₂O₄)₂⁻, (CN)₂N⁻, and C₄BO₈⁻.

The ionic liquid can be formed by freely combining the cation and the anion as described above. Each of the cation and the anion may be used singly, or in combination of two or more kinds thereof. As the anion that is combined with the cation to form the ionic liquid, Cl⁻, Br⁻, and I⁻ are preferable from the viewpoint of reversibility of cathode reaction and storage capacity. Specific preferable examples of the ionic liquid include a dialkylimidazolium halide, an ethyltributylphosphonium halide, and a tetraalkylammonium halide. As the dialkylimidazolium halide, it is possible to preferably use a 1,3-dialkylimidazolium halide such as 1-ethyl-3-methylimidazolium chloride ([EMIM].Cl), 1-ethyl-3-methylimidazolium bromide ([EMIM].Br), 1-ethyl-3-methylimidazolium iodide ([EMIM].I), 1-butyl-3-methylimidazolium chloride ([BMIM].Cl), 1-butyl-3-methylimidazolium bromide ([BMIM].Br) or 1-butyl-3-methylimidazolium iodide ([BMIM].I).

Further, as the ethyltributylphosphonium halide, it is possible to preferably use ethyltributylphosphonium chloride ([EBP].Cl), ethyltributylphosphonium bromide ([EBP].Br), ethyltributylphosphonium iodide ([EBP].I) or the like.

As the tetraalkylammonium halide, it is possible to preferably use tetraethylammonium bromide ([E₄N].Br), trimethylethylammonium chloride ([M₃EN].Cl), tetrabutylammonium chloride ([Bu₄N].Cl) or the like.

The electrolyte in the present invention can usually have a metal salt, in addition to the ionic liquid and the non-aqueous solvent described later. The metal salt can be used without particular limitation as long as the metal salt contains a metal ion which conducts between the anode and the air cathode. Examples of the metal salt include an aluminum salt. Examples of the aluminum salt include inorganic aluminum salts such as aluminum halides (e.g., AlCl₃ and aluminum bromide), and organic aluminum salts. In a case where the metal salt is contained, the content of the metal salt in the electrolyte is preferably in the range of 40 to 80 wt %, and more preferably in the range of 50 to 70 wt %.

From the viewpoint of providing a highly practical metal-air battery, the combination of the ionic liquid and the metal salt is preferably a combination of a dialkylimidazolium halide and an aluminum halide. For example, it is possible to use a combination of 1-ethyl-3-methylimidazolium bromide and AlBr₃ or a combination of 1-ethyl-3-methylimidazolium chloride and AlCl₃.

The reaction using 1-ethyl-3-methylimidazolium chloride ([EMIM].Cl) and AlCl₃ is described below as an example. An ionic liquid having ion pairs are formed by the following reactions.

[EMIM]⁺Cl⁻+AlCl₃=[EMIM]⁺[AlCl₄]⁻ (1)

[EMIM]⁺[AlCl₄]⁻+AlCl₃=[EMIM]⁺[Al₂Cl₇]⁻ (2)

[EMIM]⁺[Al₂Cl₇]⁻+AlCl₃=[Al₃Cl₁₀]⁻ (3)

Two types of deposition forms can be considered according to the molar ratio between [AlCl₃] and “EMIM”. As for a first case where [AlCl₃] is 50 mol % or less, [AlCl₃] is considered to be present as Cl⁻ and [AlCl₄]⁻. As for a second case where [AlCl₃] is more than 50 mol % (in excess), [AlCl₃] is considered to be present as [AlCl₄]⁻ and [Al₂Cl₇]⁻. As mentioned above, when an aluminum salt is mixed with an organic compound such as a dialkylimidazolium salt, the mixture forms an ion pair, thereby obtaining a melt (ionic liquid). It is considered that generation of byproducts can be suppressed because metal ions generated from the anode during discharging (e.g., aluminum ions in a case where the anode is aluminum) are more stable with the ionic liquid than with hydroxide ions. Further, aluminum ions are considered to be easily reduced to Al in the presence of multimeric anions such as [Al₂Cl₇]⁻[Al₃Cl₁₀]⁻, whereby generation of byproducts can be suppressed. In the case of using aluminum as the anode, a utility value as the anode is given.

The electrolyte in the present invention can include a non-aqueous electrolyte solution, from the viewpoint of adjusting the viscosity. The non-aqueous electrolyte solution is not particularly limited, and it is preferable that the non-aqueous electrolyte solution contain one or more selected from the group consisting of esters, carbonate esters, ethers, nitriles, and compounds in which a substituent is introduced into each of the compounds (esters, carbonate esters, ethers, and nitriles). Preferred are those selected from esters and carbonate esters. Among the esters, esters of cyclic structure are preferable, and particularly, five-membered ring γ-butyrolactone (γBL) is preferable.

Carbonate esters of either cyclic or chain structure can be used. Cyclic carbonate esters are preferably carbonate esters of five-membered ring structure. Particularly, ethylene carbonate (EC), propylene carbonate (PC), vinylene carbonate (VC), butylene carbonate, γ-butyl lactone, dimethyl carbonate (DMC), ethyl methyl carbonate (EMC), diethyl carbonate (DEC), and the like are preferable. It is also possible to use those materials together with an ionic liquid, from the viewpoint of adjusting the viscosity. The chain carbonate esters are preferably carbonate esters having 7 or less carbon atoms. Particularly, dimethyl carbonate (DMC), diethyl carbonate (DEC), and ethyl methyl carbonate (EMC) are preferable.

Ethers of either cyclic or chain structure may be used. As cyclic ethers, ethers of five-membered and six-membered ring structures are preferable. Among them, ethers containing no double bond are preferable. As chain ethers, those having 5 or more carbon atoms are preferable. Examples of the chain ethers include tetrahydropyran, dioxane, tetrahydrofuran, 2-methyltetrahydrofuran, butyl ether, isopentyl ether, 1,2-dimethoxyethane, methyl acetate, 2-methyltetrahydrofuran 1,3-dioxolane, 4-methyl-1,3-dioxolane, diethyl ether, 3-methyloxazolidinone, methyl formate, sulfolane, and dimethylsulfoxide.

Examples of nitriles include acetonitrile and propionitrile.

The non-aqueous electrolyte solution may be used singly. Preferably, a plurality of non-aqueous electrolyte solutions is mixed and used. Particularly, carbonic esters are preferably contained. Among them, carbonate esters of five-membered ring structure are preferably contained, and particularly, EC or PC is preferably contained.

The composition of the non-aqueous electrolyte solution is preferably EC/PC, EC/γBL, EC/EMC, EC/PC/EMC, EC/EMC/DEC or EC/PC/γBL.

It is possible to convert the electrolyte in the present invention into a gel by adding the following polymers. Examples of the gel electrolyte include polymers such as polyethylene oxide (PEO), polyacrylonitrile (PAN), and polymethyl methacrylate (PMMA).

The electrolyte in the present invention may further include a separator. The separator can be disposed to ensure insulation between the air cathode and the anode. The separator is impregnated with the electrolyte, so that it is possible to secure the insulation between the air cathode and the anode and the metal ion conductivity. The separator is not particularly limited, and for example, it is possible to use a polymer nonwoven fabric (e.g., a polypropylene nonwoven fabric or a polyphenylene sulfide nonwoven fabric), a microporous film of an olefin-based resin or the like (e.g., polyethylene or polypropylene), woven fabrics or combinations thereof. Further, as the separator, it is possible to use sheets for various filters such as liquid filters, sheets for various medical and hygienic materials (such as towels, gauze, and tissues), and the like. Some of the sheets can also be layered.

The thickness of the separator is preferably in the range of 0.01 mm to 5 mm, and more preferably in the range of 0.05 mm to 1 mm, from the viewpoint of securing the insulation and thinning the battery.

### Metal-Air Battery

The metal-air battery of the present invention can usually have a battery case for housing an air cathode, an anode, and an electrolyte. The shape of the battery case is not particularly limited. Specifically, the battery case may have a desired shape, which is applied to a primary battery and a secondary battery, such as a coin type, a flat plate type, a cylindrical type or a laminate type. The battery case may be an open-air type battery case or a sealed type battery case. The open-air type battery case has a structure in which at least the air cathode can be sufficiently brought into contact with the atmosphere. On the other hand, the sealed type battery case can be provided with an introduction tube and an exhaust tube for oxygen (air) as a cathode active material. In this case, the gas introduced into the battery case preferably has a high oxygen concentration, and is more preferably pure oxygen. Further, the battery case may be provided with a structure such as an injection hole for replenishing the battery with the electrolyte solution and the like.

The method of producing the metal-air battery of the present invention will be described. The method of producing the metal-air battery of the present invention is not particularly limited, and any known method can be used. For example, in the case of producing a coin cell type metal-air battery, there is, for example, a method in which, in an inert gas atmosphere, an anode is first placed in a battery case, a separator is placed on the anode, an electrolyte solution is injected from the top of the separator, an air cathode having a catalytic layer and a cathode current collector is disposed with the catalytic layer facing the separator side and then placed in the battery case at the air cathode side, and these materials are finally caulked. However, the production method is not limited to this method.

The metal-air battery of the present invention can be used for a primary battery or a secondary battery. The metal-air battery of the present invention can be applied to a device for which a normal primary or secondary battery can be used. Examples of the device include a mobile phone, a mobile device, a robot, a personal computer, an in-vehicle device, various home electric appliances, and a stationary power source. In addition, it goes without saying that the metal-air battery of the present invention can be applied to a memory backup power source for personal computer, mobile terminal or the like, and a power source for instantaneous power failure of personal computer, and can be suitably used for various applications in various industrial fields, such as an electric or hybrid car and a solar power generation energy storage system in combination with a solar cell.

The metal-air battery of the present invention is classified as an aluminum-air battery and has a theoretical capacity of 8100 Wh/kg.

### EXAMPLES

Hereinafter, the present invention will be described in detail with reference to Examples, but the present invention is not limited to the following Examples unless it exceeds the gist of the present invention. Note that evaluation items in Examples were measured as follows.

### (1) Charge-Discharge Characteristics

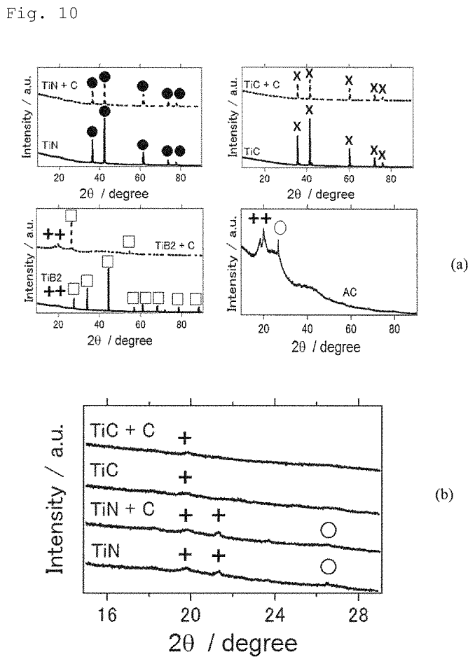

The charge-discharge characteristics of each metal-air battery obtained as follows were performed under the following conditions. Note that discharge was first performed, and charge and discharge were performed in an environment of 25° C. The metal-air battery was replenished with the electrolyte solution every time during the charge-discharge cycle. The capacity and voltage of the battery measured after 1, 5 and 25 cycles are shown in FIG. 8(a).
Discharge condition: discharge was performed at a constant current of 0.5 mA/cm² until the battery voltage reached 0.2 V.
Charge condition: charge was performed at a constant current of 0.5 mA/cm² until the battery voltage reached 1.0 V.

Similarly, the voltage versus time plot was obtained through measurement under the following conditions. The results are shown in FIG. 8(b).
Discharge condition: discharge was performed at a constant current of 2.0 mA/cm² until the battery voltage reached 0.2 V.
Charge condition: charge was performed at a constant current of 2.0 mA/cm² until the battery voltage reached 1.5 V.

### (2) Cyclic Voltammogram

Metal-air batteries obtained as follows were subjected to electrochemical measurements under the following conditions. At that time, the measured area of both electrodes was 1 cm².

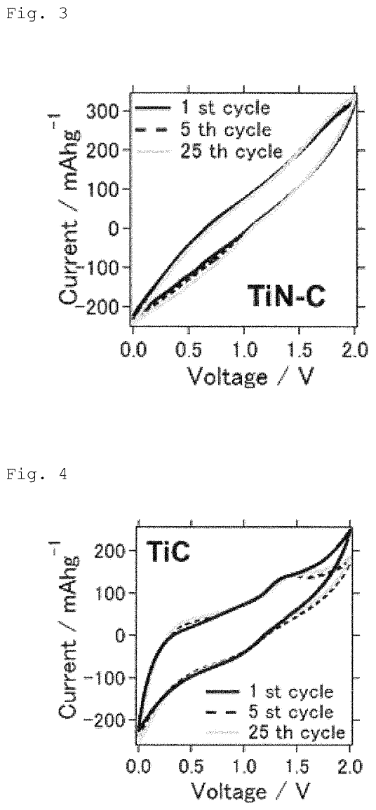

Cyclic voltammetry (0 to 2.0 V) was used as the measurement method. The measurements were performed in a two-electrode configuration (aluminum anode and air cathode). The used measuring device was galvanostat (SP-150, manufactured by BioLogic (France)). The measurement was performed at a temperature of 25° C. (left for 3 hours in a constant temperature bath before the start of measurement) and a scan rate of 10 mV/s, under atmospheric conditions obtained by oxygen substitution for 30 minutes. FIGS. 2 to 7 show the cyclic voltammograms after 1, 5, and 25 cycles.

### (3) X-Ray Diffraction Measurement (XRD)

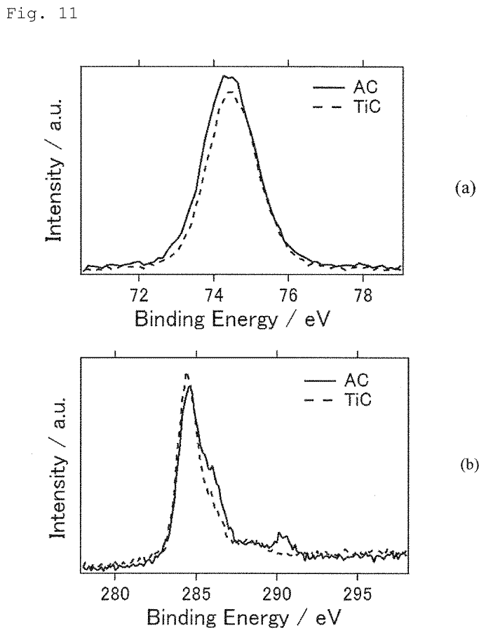

The electrode surface was measured using an X-ray diffractometer (RAD-RU, Rigaku Corporation, Cu K-alpha ray, 40 kV, 200 mA) at a scan interval of 0.03° and a scan rate of 5.0°/min (in the range of 10 to 90°). The measurement results are shown in FIGS. 9 and 10. Note that FIG. 9 shows the X-ray diffraction patterns of the anode after the electrochemical reaction, and FIG. 10 shows the X-ray diffraction patterns of the air cathodes after the electrochemical reaction.

### (4) X-Ray Photoelectron Spectroscopy (XPS)

The electrode surface was measured using an XPS measurement device (PHI 5000 VersaProbe II spectrometer, Ulvac-Phi Inc. MN, USA). The measurement results are shown in FIG. 11. Note that FIG. 9 shows the X-ray diffraction patterns of the anode after the electrochemical reaction, and FIG. 10 shows the X-ray diffraction patterns of the air cathodes after the electrochemical reaction.

### (5) Observation Using Field-Emission Scanning Electron Microscope (FE-SEM)

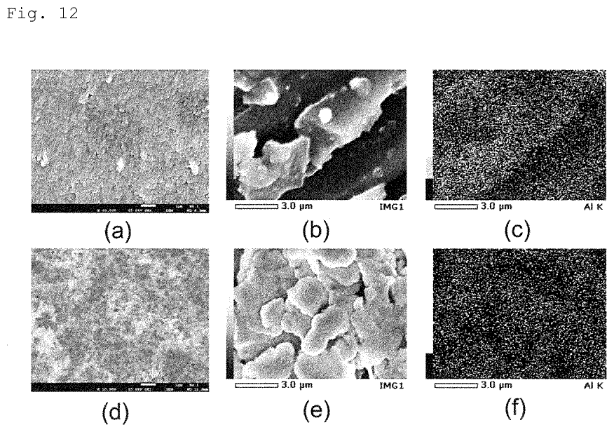

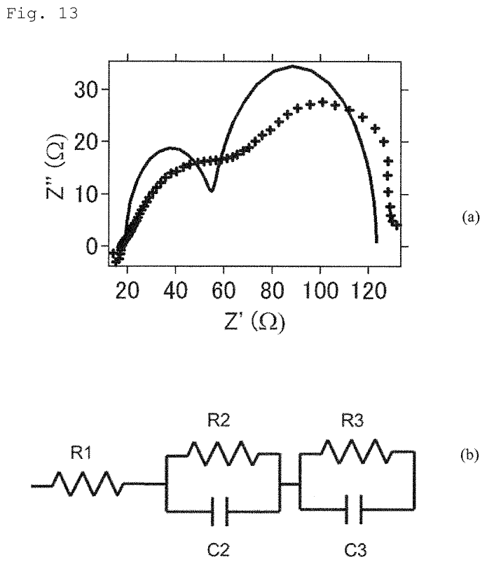

The anode and the air cathode were observed using a field-emission scanning electron microscope (JSM-7610F, manufactured by JEOL Ltd.) with an acceleration voltage of 15 kV. At that time, energy dispersive X-ray analysis (EDX) mapping was performed using the same microscope. The results are shown in FIG. 12.

### Example 1-1

### Anode

A commercially available metallic aluminum (Al A1050, 99.5% purity) having a thickness of 1 mm was cut out to φ10 mm, and an anode was produced.

### Air Cathode

Catalytic air cathode materials: TiN (Sigma Aldrich Co.), polyvinylidene fluoride (PVDF) (Sigma Aldrich Co.), and an N-methylpyrrolidone solution were weighed at a weight ratio of 1:1:2 and mixed thoroughly. Then, the resulting mixture was applied to a nickel mesh (200 μm) as a current collector so as to have a thickness of 100 μm. The nickel mesh was dried at 120° C. for 1 hour, thereby forming a catalytic layer on the nickel mesh. Thereafter, the obtained product was processed to φ10 mm, thereby obtaining an air cathode.

### Electrolyte

A mixture of 1-ethyl-3-methylimidazolium chloride and AlCl₃ (in a molar ratio of 1:2) was used as the electrolyte. A separator (φ10 mm, thickness: 100 μm, material:gauze) was impregnated with the electrolyte and used.

### Production of Metal-Air Battery

First, the anode as produced above was fitted on one side of a fluorine resin mold having an inner diameter of 10 mm and a length of 30 mm. Next, the gauze impregnated with the electrolyte, as produced above, was disposed on the anode. After that, the air cathode as produced above was disposed so that the side of the catalytic layer was in contact with the gauze to prevent the entering of air bubbles, and a metal-air battery was produced.

### Example 1-2

A metal-air battery was produced under the same conditions as those in Example 1-1 except that, in preparing an air cathode, TiN (Sigma Aldrich Co.), conductive carbon (acetylene black, manufactured by Denka Company Limited.), polyvinylidene fluoride (PVDF), and N-methylpyrrolidone solution were weighed at a weight ratio of 9:1:10:20 to produce the air cathode in Example 1-1.

### Example 2-1

A metal-air battery was produced under the same conditions as those in Example 1-1 except that, in preparing an air cathode, TiC (Sigma Aldrich Co.) was used instead of TiN to produce the air cathode in Example 1-1.

### Example 2-2

A metal-air battery was produced under the same conditions as those in Example 1-2 except that, in preparing an air cathode, TiC (Sigma Aldrich Co.) was used instead of TiN to produce the air cathode in Example 1-2.

### Example 3-1

A metal-air battery was produced under the same conditions as those in Example 1-1 except that, in preparing an air cathode, TiB₂ (Sigma Aldrich Co.) was used instead of TiN to produce the air cathode in Example 1-1.

### Example 3-2

A metal-air battery was produced under the same conditions as those in Example 1-2 except that, in preparing an air cathode, TiB₂ (Sigma Aldrich Co.) was used instead of TiN to produce the air cathode in Example 1-2.

### Example 4-1

A metal-air battery was produced under the same conditions as those in Example 1-1 except that, in preparing an air cathode, zirconium oxynitride (ZrON) was used instead of TiN to produce the air cathode in Example 1-1.

The measurement of the charge-discharge characteristics was performed using the metal-air battery, the charge-discharge characteristics similar to those of FIG. 8(a) were shown.

### Comparative Example 1

A metal-air battery was produced under the same conditions as those in Example 1-1 except that, in preparing an air cathode, activated carbon (AC, Cataler Corporation) was used instead of TiN to produce the air cathode in Example 1-1.

The above results are shown in FIGS. 2 to 13.

### Results and Discussion

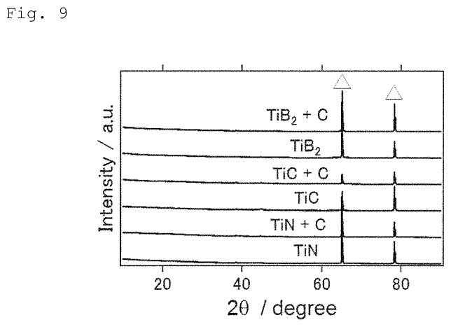

When TiN was used as the catalytic air cathode material (FIG. 2, Example 1-1), the cyclic voltammograms were exhibited up to the 25th cycle, but clear anodic or cathodic reaction peaks were not observed. On the other hand, when TiC was used as the catalytic air cathode material (FIG. 4, Example 2-1), weak anodic and cathodic reaction peaks were observed at approximately 1.5 V and approximately 1.0 V, corresponding to the dissolution and deposition of aluminum on the anode, respectively. The anodic-cathodic electrochemical reaction was stable for this system from repetitive cyclic voltammogram tests, even after 25 cycles, confirming the stability of TiN and TiC as catalytic air cathode materials. Moreover, when TiB₂ was used as the catalytic air cathode material (FIG. 6, Example 3-1), the electrochemical reaction was observed to be weaker, and the peaks were vague.

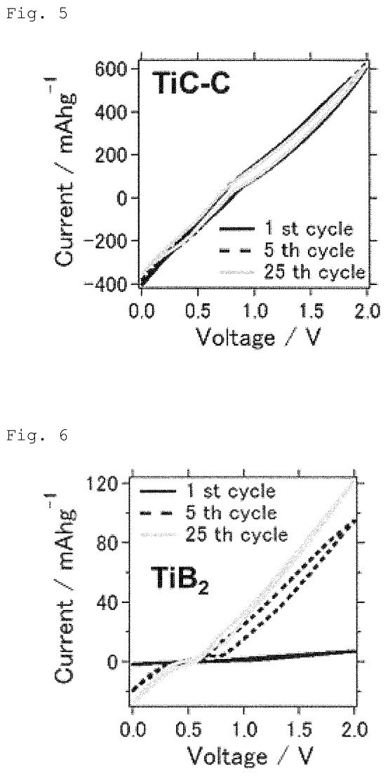

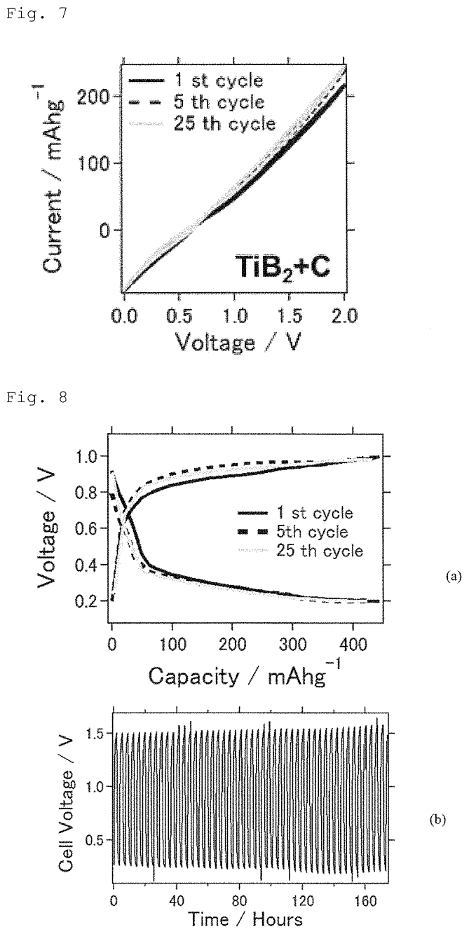

Although conductive carbon added to the air cathode generally leads to the enhancement of current, the anodic and cathodic electrochemical reactions were weakened for both TiN—C and TiC—C (FIG. 3 (Example 1-2), FIG. 5 (Example 2-2), and FIG. 7 (Example 3-2)). The aluminum metal battery that used chloroaluminate ionic liquid as the electrolyte exhibited Lewis acid base-chemistry comparable to Brønsted acidity in water.

Similarly to the fact that the proton concentration controls the chemistry and electrochemistry in the aqueous solution, chloroacidity is the major factor of speciation, reactivity, and electrochemistry in the ionic liquid. In the molten salt or the ionic liquid, Al ions are known to be present as AlCl₄⁻ (in a concentration of less than 50% AlCl₃). It has been observed that, in the case of a concentration of greater than 50% AlCl₃, Al₂Cl₇⁻ is also formed in addition to AlCl₄⁻. This is a crucial factor because the electrodeposition of Al can occur only from Al₂Cl₇.

4Al₂Cl₇⁻+3e⁻=Al+7AlCl₄⁻ (1)

In the case of the metal-air battery, the following reactions occur in the aqueous electrolyte solution during discharging:

Anode: M→M^{x+}+Xe⁻ (2)

(M: metal)

Air cathode: O₂+2H₂O+4e⁻→4OH⁻ (3)

The following reactions occur during charging:

Anode: M⁺+xe⁻→M (4)

Air cathode: 4OH⁻→O₂+2H₂O 4e⁻ (5)

The metal reduction reaction is feasible in the case of a zinc-air battery with a KOH aqueous electrolyte. However, generally in the case of an aluminum-air battery, the reduction of Al³⁺ to Al is not possible in an aqueous electrolyte. Therefore, a suitable ionic liquid for use as an electrolyte in an aluminum-air battery is highly desired because of its ability to permit the deposition of Al.

Considering the case of an Al-air battery with a suitable ionic liquid as the electrolyte, the following reactions occur upon discharging:

Anode: Al→Al³⁺+3e⁻ (6)

Air Cathode: 4Al³⁺+3O₂+8e⁻→2Al₂O₃ (7)

After that, the following reaction occurs upon charging:

Anode: Al³⁺+3e⁻→Al (8)

Air cathode: 2Al₂O₃→4Al³⁺+3O₂+8e⁻ (9)

The above Al reactions (equations (6) and (8)) were possible in the present invention as a mixture of 1-ethyl-3-methylimidazolium chloride and AlCl₃ was used as the electrolyte solution, and this point will be discussed in detail in the following section.

FIG. 8 shows the electrochemical properties of the battery using TiC as the air cathode. In the charge-discharge electrochemical reaction, TiC was used as the air cathode material as it exhibited a stable electrochemical reaction. FIG. 8(a) shows the charge-discharge curves at an applied current of ±0.5 mAcm⁻². The capacities of the TiC battery at the 1st, 5th, and 50th cycles were 444, 432, and 424 mAhg⁻¹, respectively. Approximately, 95% of cell capacity was retained after 50 times of charge-discharge reaction. FIG. 8(b) shows the voltage versus time plot by the application of charge and discharge rates of ±2.0 mA/cm² for 90 minutes each over a time. From this plot, the battery is clearly stable, with a long-term usability of approximately 1 week. From the results shown in FIGS. 8(a) and 8(b), the cell capacity and cell durability for this battery are very stable even after repeated electrochemical reactions in the air atmosphere. This crucial factor is expected to be beneficial when considering the practicality of a battery. As a stable electrochemical reaction was observed in the CV experiment, this result suggests that the cell capacity is also stable.

FIG. 9 shows the XRD patterns of the aluminum anode after the charge-discharge electrochemical reactions with the ionic liquid used (1-ethyl-3-methylimidazolium chloride/AlCl₃ mixture in a molar ratio of 1:2) for the TiN, TiC, and TiB₂ air cathodes. From this figure, aluminum hydroxide and aluminum oxide, which are typically the main byproducts of an aluminum-air battery and serve to inhibit long-term battery operation, were not observed. Similarly, byproducts have not been observed in previous studies with the use of an ionic liquid as the electrolyte in conjunction with other types of air cathode materials.

FIG. 10(a) shows the XRD patterns of the different air cathodes after the electrochemical reaction. With the use of activated carbon, TiB₂, and TiB₂—C as air cathodes, the Al(OH)₃ byproduct was observed in each case. In the case of activated carbon, Al₂O₃ was also detected. Upon close observation, a small amount of Al(OH)₃ was observed for TiN- and TiC-based air cathodes (FIG. 10(b)). Notably, the TiN- and TiC-based aluminum-air battery samples were taken after 1 week or more of electrochemical reactions. Thus, although byproduct formation was not completely eliminated, to the best of our knowledge, this is the first report for the suppression of byproduct accumulation on the air cathode of an aluminum-air battery, which is beneficial when considering the practical use of these batteries.

In the ionic liquid, the reactions (7) and (9) occur, which results in the production of Al₂O₃. Therefore, in the air cathode of the battery system, accumulation of byproducts is suppressed, so the following reaction may occur:

O₂+2e⁻+EMI-Cl→[EMI-O₂⁺⁻]+Cl⁻ (10)

The influence of humidity (water) should also be considered as 1-ethyl-3-methylimidazolium chloride is a hydrophilic ionic liquid. Therefore, the ionic liquid absorbs the moisture from the ambient atmosphere, resulting in the presence of water in the electrolyte solution. In the case of an aqueous electrolyte, the oxygen reduction reaction proceeds with two main possible pathways: one involving the transfer of 2e to produce peroxide (H₂O₂), and the other involving the production of water via direct 4e transfer of hydrogen peroxide. The two pathways are expressed by equations (11) and (12), respectively.

Direct 4e⁻pathway: O₂+4H⁺+4e⁻→2H₂O (11)

2e⁻pathway: O₂+2H⁺+2e⁻→2H₂O₂ (12)

2H₂O₂+2H⁺+2e⁻→2H₂O (13)

Both metal nitride and metal carbide have been reported as excellent electrocatalysts for the oxygen reduction and evolution reactions involving the direct 4e pathway. Thus, the reactions (10) and (11) may occur in the battery system.

FIG. 11 shows the XPS spectra of the AC and TiC air cathodes following the electrochemical reactions. Generally, the 2p peak of Al is observed at about 73 eV. The air cathode composed of AC or TiC shows a peak slightly higher than 74 eV, indicating that Al is present as aluminum oxide or aluminum chloride (FIG. 11(a)). It is difficult to determine the difference in byproduct accumulation between the two air cathode materials. FIG. 11(b) shows the XPS spectra of C is orbital for both the air cathodes. No obvious difference between the two air cathodes was observed at around the 285 eV peak. However, an additional peak corresponding to carbon atoms present in the form of metallic carbonates was observed at about 290 eV in the AC air cathode. From the results, the accumulation of byproducts on the AC air cathode possibly originates from aluminum carbonate. For the TiC air cathode, this chemical reaction was somehow suppressed. However, this speculation on the reasoning for byproduct accumulation needs to be further examined to reach a reasonable conclusion.

The morphology of the AC and TiC air cathode materials was examined. FIG. 12 shows the FE-SEM images of the AC and TiC air cathodes before and after the electrochemical reactions. For the air cathode samples after the electrochemical reaction, the image was recorded of the side facing the electrolyte. FIGS. 12(a) and 12(d) show the FE-SEM images of the AC and TiC air cathodes before the electrochemical reactions, respectively. FIG. 12(b) shows the surface of the AC air cathode after electrochemical reaction, and FIG. 12(c) shows the EDX mapping images of the Al atoms present in FIG. 12(b). Similarly, FIG. 12(e) shows the surface of the TiC air cathode after the electrochemical reaction, and FIG. 12(f) shows the EDX mapping images of the Al atoms present in FIG. 12(e). These images indicate that byproducts such as Al(OH)₃ and Al₂O₃ do not accumulate in the form of large crystals on the air cathode in the atmosphere. Basically, aluminum atoms were evenly located throughout the whole surface. In the case of the AC air cathode, an Al(OH)₃ phase or an Al₂O₃ phase was detected by XRD (FIG. 10(a)).

Table 1 summarizes the atomic percentages of the air cathode materials of the samples observed by EDX analysis, where (a) shows the AC air cathode before the electrochemical reaction, (b) shows the AC air cathode after the electrochemical reaction, (d) shows the TiC air cathode before the electrochemical reaction, and (e) shows the TiC air cathode after the electrochemical reaction.

TABLE 1

| atom | (a) | (b) | (d) | (e) |
|---|---|---|---|---|
| C | 80.5 | 81 | 73.2 | 73 |
| O | 0.77 | 8.8 | 6.1 | 3.9 |
| F | 18.8 | 5.8 | 18.55 | 19 |
| Al | | 1.7 | | 0.1 |
| Cl | | 2.7 | | 0.9 |
| Ti | | | 2.15 | 3.2 |

In Table 1, as a whole, the percentage of carbon atoms was large because a conductive carbon coating was applied to the sample surfaces for the purpose of SEM observation. The fluoride atoms corresponded to PVDF, which is a component material used in the production of air cathodes. However, the percentages of both aluminum and chloride were smaller for the TiC air cathode as compared to the AC air cathode after the electrochemical reaction. Thus, even though the existence of aluminum and chloride atoms is confirmed on the TiC air cathode, these atoms tend to accumulate to a greater extent on carbonaceous materials, such as activated carbon, than on non-oxide ceramic materials, such as titanium carbide. Furthermore, the atomic percentage ratio of chloride/aluminum was larger for TiN than AC, which could be the reason for less byproducts formation such as Al₂O₃ or Al(OH)₃, due to the uneven ratio of chloride/aluminum.

FIG. 13(a) shows the Nyquist plot for the intact aluminum-air batteries with TiN as the air cathode before the occurrence of the electrochemical reaction. FIG. 13(b) shows the equivalent circuits for simulating this process. Table 2 summarizes the simulation values obtained by using EC Lab software for the equivalent elements.

TABLE 2
TiN

| | 0 h | 24 h | 48 h | 72 h |
|---|---|---|---|---|
| R1(Ω · cm²) | 9.866 | 11.38 | 13.43 | 14.92 |
| C2(F · cm⁻²) | 1.13 × 10⁻³ | 8.35 × 10⁻³ | 2.45 × 10⁻² | 6.82 × 10⁻² |
| R2(Ω · cm2) | 87.43 | 175.76 | 468.45 | 789.45 |
| C3(F · cm−2) | 2.50 × 10⁻⁵ | 4.57 × 10⁻⁵ | 8.28 × 10⁻⁵ | 2.35 × 10⁻⁴ |
| R3(Ω · cm2) | 69.43 | 75.43 | 86.58 | 107.54 |

TiN + C

| | 0 h | 24 h | 48 h | 96 h |
|---|---|---|---|---|
| R1(Ω · cm²) | 3.54 | 4.57 | 5.86 | 6.54 |
| C2(F · cm⁻²) | 2.45 × 10⁻³ | 3.56 × 10⁻³ | 5.78 × 10⁻³ | 8.67 × 10⁻³ |
| R2(Ω · cm2) | 67.83 | 89.54 | 128.54 | 151.65 |
| C3(F · cm−2) | 3.75 × 10⁻⁵ | 8.45 ×10⁻⁵ | 6.65 × 10⁻⁴ | 7.23 × 10⁻⁴ |
| R3(Ω · cm2) | 37.34 | 46.54 | 67.32 | 98.65 |

TiC

| | 0 h | | 48 h | 96 h |
|---|---|---|---|---|
| R1(Ω · cm2) | 18.54 | 20.43 | 23.65 | 24.98 |
| C2(F · cm−2) | 3.76 × 10⁻³ | 4.92 × 10⁻³ | 7.02 × 10⁻³ | 2.34 × 10⁻⁴ |
| R2(Ω · cm2) | 97.43 | 136.65 | 167.54 | 198.35 |
| C3(F · cm−2) | 6.96 × 10⁻⁵ | 7.28 × 10⁻⁵ | 9.65 × 10⁻⁵ | 2.04 × 10⁻⁴ |
| R3(Ω · cm2) | 128.45 | 149.84 | 176.76 | 202.45 |

TiC + C

| | 0 h | | 48 h | 96 h |
|---|---|---|---|---|
| R1(Ω · cm2) | 12.56 | 15.75 | 17.54 | 19.54 |
| C2(F · cm−2) | 2.81 × 10⁻³ | 2.98 × 10⁻³ | 4.56 × 10⁻³ | 6.19 × 10⁻³ |
| R2(Ω · cm2) | 68.34 | 96.07 | 112.65 | 139.65 |
| C3(F · cm−2) | 2.71 × 10⁻⁵ | 3.26 × 10⁻⁵ | 4.76 × 10⁻⁵ | 6.58 × 10⁻⁵ |
| R3(Ω · cm2) | 48.65 | 56.09 | 72.76 | 114.96 |

TiB₂

| | 0 h | | 48 h | 96 h |
|---|---|---|---|---|
| R1(Ω · cm2) | 34.65 | 45.65 | 49.32 | 52.76 |
| C2(F · cm−2) | 3.76 × 10⁻² | 4.99 × 10⁻² | 6.29 × 10⁻² | 7.37 × 10⁻² |
| R2(Ω · cm2) | 578.69 | 643.27 | 809.54 | 977.31 |
| C3(F · cm−2) | 1.98 × 10⁻⁵ | 2.79 × 10⁻⁵ | 4.81 × 10⁻⁵ | 5.76 × 10⁻⁵ |
| R3(Ω · cm2) | 34.86 | 48.21 | 68.43 | 98.65 |

TiB₂ + C

| | 0 h | | 48 h | 96 h |
|---|---|---|---|---|
| R1(Ω · cm2) | 12.56 | 25.65 | 38.65 | 54.45 |
| C2(F · cm−2) | 3.61 × 10⁻³ | 5.33 × 10⁻³ | 7.19 × 10⁻³ | 9.27 × 10⁻³ |
| R2(Ω · cm2) | 85.54 | 120.82 | 143.99 | 187.54 |
| C3(F · cm−2) | 1.68 × 10⁻⁵ | 2.81 × 10⁻⁵ | 3.17 × 10⁻⁵ | 5.47 × 10⁻⁵ |
| R3(Ω · cm2) | 24.76 | 39.77 | 53.69 | 71.81 |

In general, R1 is regarded as the resistance of the electrolyte solution (Rs, resistance of the solution), and R2 is the resistance to the transfer of charge carriers at the electrode-electrolyte interface (Rc, resistance to charge transfer). R3 is regarded as the resistance to ion diffusion. When conductive carbon was added to the air cathode electrode, the resistance was lower because of the enhanced conductivity in the batteries. As a whole, as compared to R1, R2 and R3, resistance values were found to be higher, and the degree of increase for these resistance values was more rapid with the progress of the electrochemical reaction. It is suggested that even though the amounts of byproducts such as Al(OH)₃ and Al₂O₃ are low, these byproducts contribute to the high resistance and resistance increase in the battery. For TiB₂, the resistance and resistance increase were observed to be greater as compared to those observed for the TiN- and TiC-based batteries, indicating that as Al(OH)₃ is detected as a byproduct, the resistance and its increase are more dominant as compared to those of TiN- and TiC-based batteries.

### DESCRIPTION OF REFERENCE SIGNS

1 anode
2 electrolyte
3 air cathode

1. A metal-air battery comprising:
an anode;
an air cathode; and
an electrolyte that is interposed between the anode and the air cathode,
wherein
the anode contains aluminum,
the electrolyte contains an ionic liquid,
a cation in the ionic liquid is at least one selected from the group consisting of imidazolium, pyridinium, ammonium, pyrrolidinium, pyrazolium, piperidinium, morpholinium, sulfonium, and phosphonium,
an anion in the ionic liquid is at least one selected from the group consisting of a halogen ion, an amide ion, an imide ion, a fluoride ion, a sulfate ion, a phosphate ion, a fluorosulfate ion, a lactate ion, and a carboxylate ion, and
the air cathode contains a non-oxide ceramic.

2. The metal-air battery according to claim 1, wherein the non-oxide ceramic contains a metal carbide, a metal nitride, a metal boride, a metal oxynitride, a metal carbonitride or a metal silicide.

3. The metal-air battery according to claim 1, wherein a metal constituting the non-oxide ceramic is at least one selected from the group consisting of titanium, zirconium, sodium, calcium, barium, magnesium, aluminum, silicon, vanadium, chromium, manganese, iron, cobalt, nickel, copper, zinc, gallium, yttrium, niobium, tin, tungsten, tantalum, indium, lanthanum, lead, strontium, bismuth, cerium, molybdenum, and hafnium.

4. The metal-air battery according to claim 1, wherein the non-oxide ceramic is at least one selected from the group consisting of titanium nitride and titanium carbide.

5. The metal-air battery according to claim 1, wherein the air cathode contains the non-oxide ceramic and carbon.

6. (canceled)

7. The metal-air battery according to claim 1, wherein the metal-air battery is used as a primary battery or a secondary battery.
